(19) United States
(12) Patent Application Publication
(10) Pub. No.: US 2025/0027549 A1
(43) Pub. Date: Jan. 23, 2025

(54) WHEEL-MOUNTED BRAKE DISC FOR RAIL VEHICLES

(71) Applicant: KNORR-BREMSE Systeme für Nutzfahrzeuge GmbH, Munich (DE)

(72) Inventors: Bernhard HAEMMERL, Maisach (DE); Maro-Gregory ELSTORPFF, Munich (DE); Jury MESHENBERG, Karlsfeld (DE); Michael MATHIEU, Schondorf (DE)

(21) Appl. No.: 18/786,534

(22) Filed: Jul. 28, 2024

Related U.S. Application Data
(63) Continuation of application No. PCT/EP2023/051854, filed on Jan. 26, 2023.

(30) Foreign Application Priority Data
Jan. 31, 2022 (DE) DE102022102204.8

(51) Int. Cl. F16D 65/12; F16D 65/02

(52) U.S. Cl. CPC F16D 65/124; F16D 65/128; F16D 2065/1328; F16D 2065/134

(57) ABSTRACT

A wheel-mounted brake disk including at least two friction disks, arranged on both sides of a stem of a wheel body of a rail wheel and fastened by fasteners, wherein the at least two friction disks include cooling fins and fastening bosses, wherein the fasteners extend through the fastening bosses of the at least two friction disks and through the stem, wherein the at least two friction disks include round stems, and at least one annular fin, wherein the round stems and the at least one annular fin form the cooling fins.

### RELATED APPLICATIONS

This application is a continuation of International patent application PCT/EP2023/051854 claiming priority German patent application DE10 2022 102 204.8, both of which are incorporated in their entirety by this reference.

### FIELD OF THE INVENTION

The invention relates to a wheel mounted brake disc for rail vehicles.

### BACKGROUND OF THE INVENTION

A generic wheel-mounted brake disk for rail vehicles is typically attached to the wheel body of a rail wheel.

This is represented in FIGS. 1-2, in partial schematic details of a schematic radial sectional view of a wheel body 1 that has a stem 1a, an axis 1b and has a wheel-mounted brake disk 2 according to the prior art. FIG. 3, in addition, shows a schematic top view of a rear side R of a friction disk 2a, 2b of the wheel-mounted brake disk 2 according to FIGS. 1 to 2 of the prior art.

The wheel-mounted brake disk 2 has two friction disks 2a, 2b, having a respective friction face RF. On rear sides R of the friction disks 2a, 2b, fastening bosses 4 that each have a respective contact surface AF and respective through-hole 4a, and that are distributed in a uniform manner over a diameter, project parallel to the direction of the axis 1b. The two friction disks 2a, 2b are clamped together against a wheel disk, or against the stem 1a of the wheel body 1, by means of fasteners 4b, in this case through-bolts, which extend through the through-holes 4a.

Twisting of the friction disks 2a, 2b on the wheel disk, or on the stem 1a, is usually prevented in this case by radially arranged sliding blocks (not shown) in radial slots 19. These also absorb all the forces acting upon the wheel disk in the tangential direction, such as, for example, the friction force between the brake lining (not shown, but easy to visualize) and the friction disk 2a, 2b, and transfer them into the wheel body 1 of the assigned wheel.

The wheel-mounted brake disk 2 is provided with cooling fins 3 that enlarge the cooling surface in cooling channels K between the cooling fins 3 and between the cooling fins 3 and the bosses 4 and, at the same time, have a highly ventilating effect when the wheel-mounted brake disk 2 rotates, which generally results in a strong and effective cooling effect. The ventilating effect of the cooling fins 3 causes ventilation of the air, which is drawn in, at a respective inner diameter 5 of the friction disks 2a, 2b, through air inlets 7 into the cooling channels K and, as a result of the centrifugal force caused by rotation, exits radially as air flows 7a at an outer diameter 6 of the cooling channel, or of the friction disk 2a, 2b, through air outlets 8, as an air flow 8a.

This is shown in FIG. 3 together with a distribution of the cooling fins 3 and fastening bosses 4 on the rear side R of the friction disk 2a, 2b. The cooling fins 3 extend substantially in a radial direction from the inner diameter 5 to the outer diameter 6. In the region of the fastening bosses 4, the cooling fins 3 are divided into two parts by the respective fastening boss 4.

The cooling fins 3 in this case are arranged with contact surfaces for contact with the stem 1a. At a mid-diameter, the fastening bosses 4 are likewise arranged with contact surfaces for contact with the stem 1a.

FIGS. 4 and 5 show further examples of friction disks 2a, 2b, having different cooling fins 3, 3a-3e, from the prior art.

In FIG. 4, the cooling fins 3 extend in a straight line in the radial direction of the friction disk 2a, 2b, and are not interrupted by the fastening bosses 4.

Represented in FIG. 5 are cooling fins 3a-3e that are arranged as circular arc segments, of differing arc lengths, on five coaxial circles between the inner diameter 5 and outer diameter 6 of the friction disk 2a, 2b.

FIG. 6 shows a schematic perspective view of an axle-mounted brake disk 2 according to prior art, which has so-called round stems 9.

FIG. 7, in addition, shows a partial detail of the axle-mounted brake disk 2. Here, the round stems 9 have a double-cone shape, with the smaller diameter arranged in the center of each round stem 9. Air outlets 8 for the emerging air flows 8a form gaps SP, and are each formed by two round stems 9 between the friction disks 2a, 2b, at their outer diameters 6, with the length of the gap SP being the distance between the rear sides R of the friction disks 2a, 2b.

It is considered to be disadvantageous that, in view of the high fan power loss generated, it cannot be said that an efficient cooling effect is achieved.

### BRIEF SUMMARY OF THE INVENTION

The object of the invention is therefore to create an improved wheel-mounted brake disk with reduced fan power loss and increased cooling effect for the wheel-mounted brake disk.

The object is achieved by A wheel-mounted brake disk including at least two friction disks, arranged on both sides of a stem of a wheel body of a rail wheel and fastened by fasteners, wherein the at least two friction disks include cooling fins and fastening bosses, wherein the fasteners extend through the fastening bosses of the at least two friction disks and through the stem, wherein the at least two friction disks include round stems, and at least one annular fin, wherein the round stems and the at least one annular fin form the cooling fins.

A concept of the invention is that the surface area of the friction disk is maximized in the cooling channel and, at the same time, the air-conveying effect of these surface-enlarging elements is kept low.

A wheel-mounted brake disk according to the invention comprises at least two friction disks, which are arranged on both sides of a stem of a wheel body of a rail wheel and fastened by means of fasteners, wherein the at least two friction disks have cooling fins and fastening bosses, wherein the fasteners extend through the fastening bosses of both friction disks and the stem. The at least two friction disks have round stems and at least one annular fin as cooling fins.

The wheel-mounted brake disk according to the invention thus has the advantage of a combination of design features. The ventilation of the air, which is drawn into the cooling channel at the inner diameter of the friction disk and exits radially at the outer diameter of the cooling channel as a result of the centrifugal force caused by rotation, is restricted and at the same time there is the advantageous result that the ventilated air volume efficiently cools the friction disk, which is heated during braking.

In this way, the surface area of the friction disk can be maximized in the cooling channel by means of the round stems, while at the same time the air-conveying effect of these surface-enlarging elements can be kept low.

In one embodiment, the round stems are arranged on circles of differing diameters on the at least two friction disks, wherein the at least one annular fin is arranged as a circumferential annular fin on a circle having a diameter that is located at an outer diameter of each of the at least two friction disks.

In terms of flow, these round stems cause swirling of the radially flowing air, thereby generating, with regard to the volume of air conveyed, a very efficient thermodynamic transfer of heat to the turbulent air flow generated in this way.

The annular fin was selected for the advantageous restriction of the air volume conveyed. At the same time, the annular fin offers the further advantage that it, in turn, also effects a further enlargement of the cooling surface area in the cooling channel.

A further embodiment provides for the at least two friction disks to have further round stems, which are connected by the annular fin. This is advantageous because, as a result, the cooling surface area is enlarged and, in addition, the annular fin is stiffened.

It is provided in this case that the round stems connected by the annular fin are arranged at regular angular intervals in relation to one another, wherein the angular interval has an angular value that is in a range of from 3° to 15°, preferably 5° to 10°, or is preferably 5°. This results in an advantageous, stable structure.

In a further embodiment, to enable an advantageous, simple structure to be achieved, the round stems connected by the annular fin may have a circular-cylindrical cross-section. Other cross-sections are, of course, also conceivable.

In a yet further embodiment, the round stems connected by the annular fin project further in axial length, to a particular, predeterminable extent, from a rear side of the friction disk than does the annular fin. In this way, the air outlet can be influenced in an advantageous manner.

In addition, it is provided in a further embodiment that a respective portion of the annular fin between respectively two round stems and the stem of the wheel body to be assigned forms an aperture portion as a gap for an air outlet. A particular advantage here is that the main function is to form a gap between the friction disks and the stem of the rail wheel. This gap at the air outlet from the cooling channel may be made individually wider or narrower, depending on the requirements of different projects.

Further advantageous designs are given in the dependent claims.

In a yet further embodiment, the round stems that are connected by the annular fin each have contact surfaces for bearing against the stem of the wheel body to be assigned. This results in an advantageous, stable structure.

If first round stems have contact surfaces for bearing against the stem of the wheel body to be assigned, wherein second and third round stems are shorter in the axial direction by a certain amount than the first round stems, an advantageous result is that it is possible to achieve a stable structure with conveyance of air and swirling of the air flows.

In a yet further embodiment, the first round stems that have the contact surfaces are arranged on a first circle that has a first diameter, wherein the first circle is located at an inner diameter of the respective friction disk.

In another embodiment, it is provided that the round stems have a conical shape, the largest diameter of which is located on the surface of the rear side of the at least two friction disks. The conveyance of air and the swirling of the air flows can thus be influenced in an advantageous manner.

### BRIEF DESCRIPTION OF THE DRAWINGS

Exemplary embodiments of the invention are described below with reference to the accompanying drawings. These exemplary embodiments serve merely to illustrate the invention on the basis of preferred designs, but they are not an exhaustive representation of the invention. In this respect, other exemplary embodiments as well as modifications and equivalents of the represented exemplary embodiments can also be realized within the scope of the claims.

FIGS. 1-2 show partial schematic details of a schematic radial sectional view of a wheel body having a wheel-mounted brake disk according to the prior art;

FIG. 3 shows a schematic top view of a rear side of a friction disk of the wheel-mounted brake disk of FIGS. 1 to 2 according to the prior art;

FIGS. 4-5 show schematic top views of wheel-mounted brake disks according to the prior art;

FIGS. 6-7 show schematic views of an axle-mounted brake disk according to the prior art;

FIGS. 8-9 show schematic perspective views of a rear side of a friction disk of a wheel-mounted brake disk according to the invention;

FIG. 10 shows a partial schematic detail of a schematic radial sectional view of a wheel body having the wheel-mounted brake disk according to the invention of FIGS. 8-9; and

FIG. 11 shows a schematic partial side view of the wheel-mounted brake disk according to the invention of FIGS. 8-10.

### DETAILED DESCRIPTION

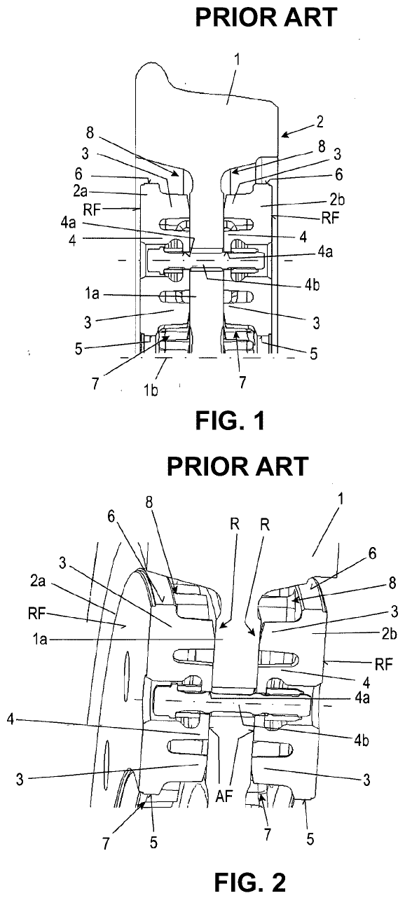

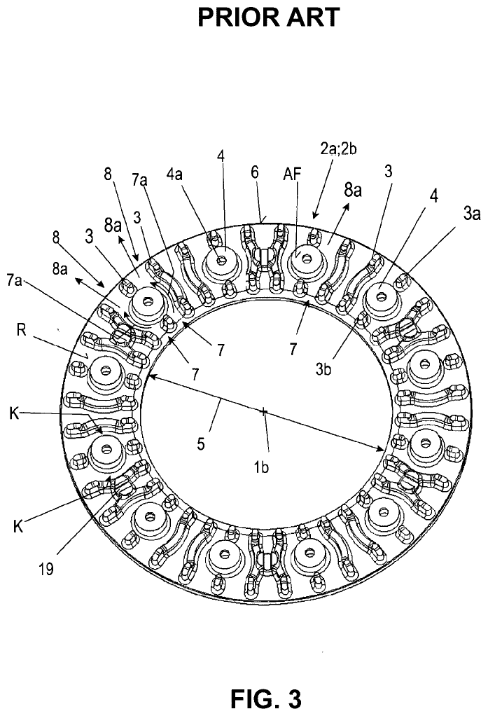

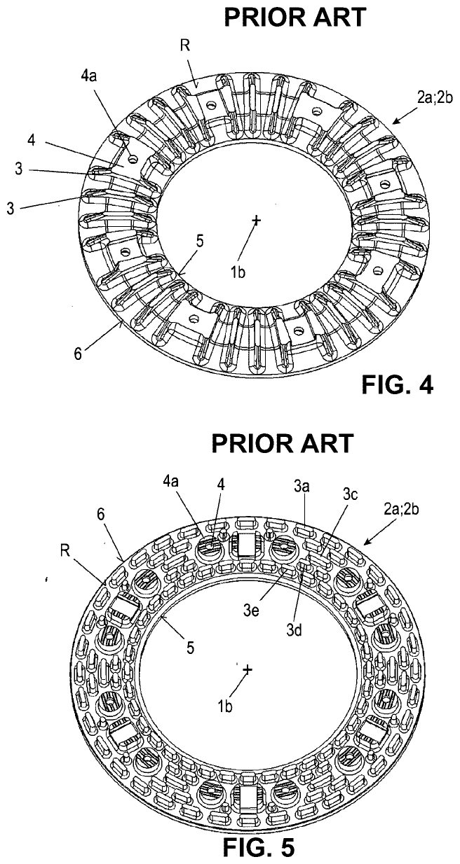

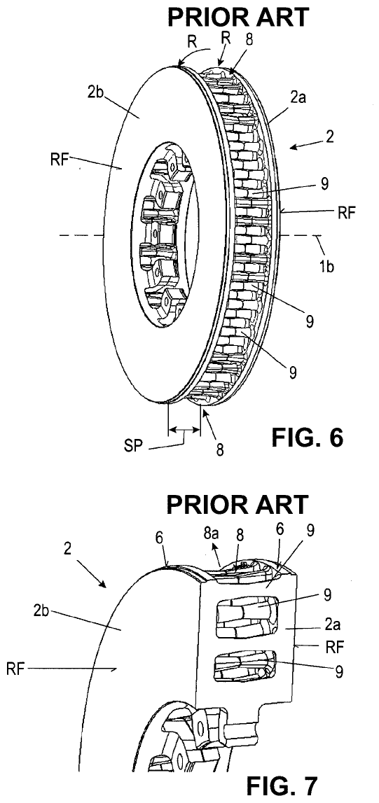

FIGS. 1-7 have already been described above.

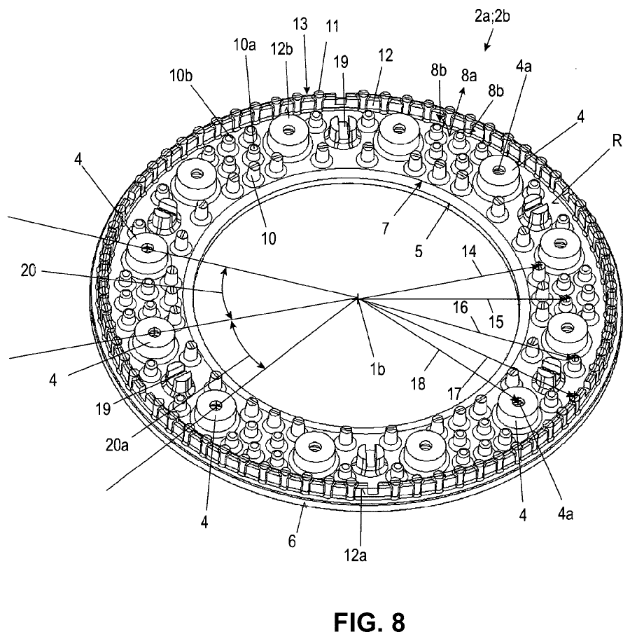

FIG. 8 shows a schematic perspective view of a rear side R of a friction disk 2a, 2b of wheel-mounted brake disk 2 according to the invention.

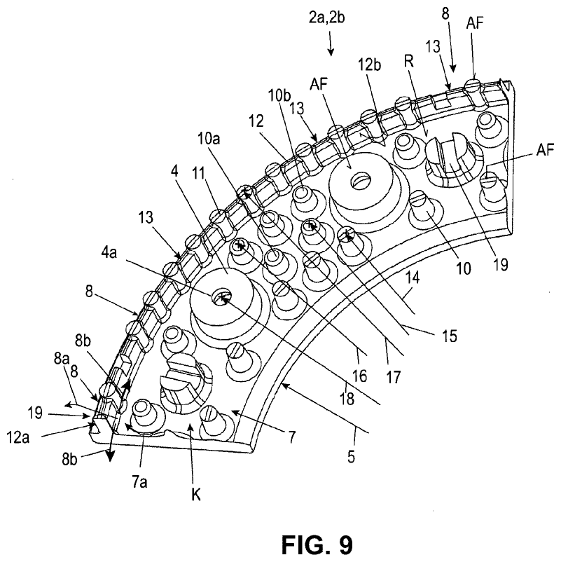

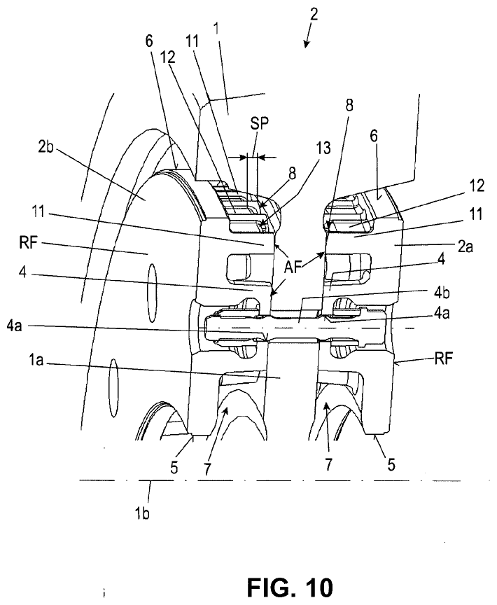

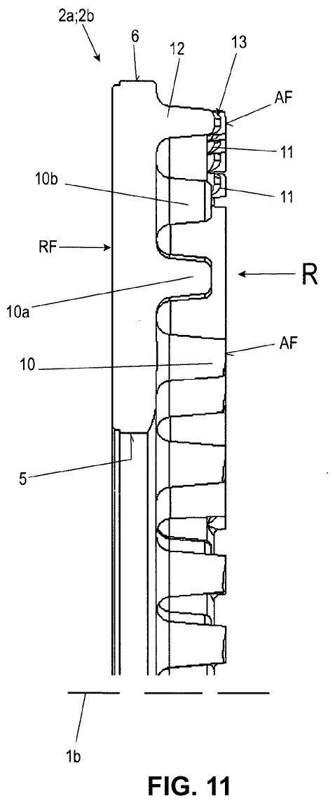

FIG. 9 shows an enlarged partial detail of the friction disk 2a, 2b according of FIG. 8. FIG. 10 shows a partial schematic detail of a schematic radial sectional view of a wheel body 1 having the wheel-mounted brake disk 2 according to the invention. FIG. 11 shows a partial schematic side view of a friction disk 2a, 2b of the wheel-mounted brake disk 2 according to the invention of FIGS. 8 to 10.

For a better overview, the friction disk 2a, 2b in FIG. 8 is divided in the radial direction into four circles, having diameters 14, 15, 16, 17 and delimited by the inner diameter 5 and outer diameter 6. The smallest diameter is the inner diameter 5, followed in ascending order by the four diameters 14, 15, 16, 17, up to the outer diameter 6. The first circle, having the first diameter 14, is located at the inner diameter 5.

Arranged in a distributed manner over the friction disk 2a, 2b are circle sectors 20, 20a, of which only two are identified here, as examples. Each circle sector 20, 20a is defined by two notional radial dividing lines. Arranged on each dividing line there is a fastening boss 4, of what is here a total of twelve fastening bosses 4, as an example. Here, an angle between two dividing lines of each circle sector 20, 20a is 30°. The circle sectors 20, 20a differ primarily in that in the circle sectors 20a there are radial slots 19 arranged between the 4.

The fastening bosses 4 are arranged at equal angular intervals in relation to one another on a diameter 18, which is approximately a mid-diameter of the friction disk 2a, 2b.

To form the surface-enlarging elements in the cooling channels K (see FIG. 9), so-called round stems 10, 10a, 10b have been selected here.

In terms of flow, these round stems 10, 10a, 10b cause swirling of the radially flowing air, thereby generating, with regard to the volume of air conveyed, a very efficient thermodynamic transfer of heat to the air. In other words, a turbulent air flow is generated, the heat transfer of which is greater than in the case of laminar air flow.

The round stems 10, 10a, 10b are attached to, or formed onto, the rear side R of the friction disk 2a, 2b, on the circles having the differing diameters of 14, 15, 16, 17. They project in the axial direction from the rear side R of the friction disk 2a, 2b.

First round stems 10 are arranged on the first diameter 14, second round stems 10a on the second diameter 15, and third round stems 10b on the third diameter 16.

The first round stems 10 are arranged, on the first diameter 14, in groups of three in the circle sectors 20 and in groups of two in the circle sectors 20a.

The second round stems 10a, in the second diameter 15, are present only in the circle sectors 20 between two fastening bosses 4.

And on the third diameter 16, the third round stems 10b are arranged in groups of three in the circle sectors 20 and in groups of two in the circle sectors 20a.

Here, the round stems 10, 10a, 10b have a conical shape, the largest diameter being located on the surface of the rear side R. The round stems 10, 10a, 10b differ here in their axial lengths. Thus, the first round stems 10 have contact surfaces AF, by which they bear against the stem 1a of the wheel body 1. The second and third round stems 10a, 10b are shorter than these and have a space between their upper sides and the stem 1a. This can be seen in FIG. 11.

To restrict the volume of air being conveyed, an annular fin 12 has been selected, this being arranged close to the outer diameter 6 of the friction disk 2a, 2b, extending around the fourth diameter 17.

The annular fin 12 has an outer side 12a, which faces toward the outer diameter 6, and an inner side 12b. The annular fin 12 connects a number of round stems 11, which have a circular-cylindrical cross-section. In the example shown, there are sixty-six round stems 11, with one round stem 11 being omitted in each circle sector 20a due to the radial slot. The round stems 11 are arranged at regular angular intervals in relation to one another. In this example, the angular interval between the round stems is 5°. The angular interval may have an angular value that lies in a range of, for example, 3° to 15°, preferably 5° to 10°.

The round stems 11 project further in axial length, to a particular, predeterminable extent, from the rear side R of the friction disk 2a, 2b than does the annual fine 12, and each have contact surfaces AF for bearing against the stem 1a. In this way, a respective portion of the annular fin 12, between respectively two round stems 11 and the stem 1a, forms an aperture portion 13.

This annular fin 12, in turn, also effects a further enlargement of the cooling surface in the cooling channels K, the main function being the formation of a gap SP between the friction disks 2a, 2b and the stem 1a of the wheel body 1. This gap SP is clearly visible in FIG. 10. The gap SP is the distance between the aperture portion 13 of the annular fin 12 between two round stems 11 at the air outlet 8 from the cooling channel K, and may be made individually wider or narrower, depending on the requirements of different applications.

The restriction of the volume of air, or air flow 7a, is represented in an enlarged form in FIG. 9. The air flow 7a from the air inlet 7 flows against the annular fin 12 and, on the one hand, is deflected axially upward over the annular fin 12, through the aperture portion 13, as air flow 8a into the air outlet 8. On the other hand, when the air flow 7a impinges on the inner side 12b of the annular fin 12, it is divided tangentially to the left and right into further air flows 8b.

The wheel-mounted brake disk 2 thus has a low fan power loss, due to air ventilation in the region of the cooling channel K between the friction disk 2a, 2b and the wheel body 1, but with the greatest possible cooling effect for the friction disk 2a, 2b.

The invention is not limited by the exemplary embodiment given above, but can be modified within the scope of the claims.

### REFERENCE NUMERALS AND DESIGNATIONS

1 wheel body
1a stem
1b axis
2 wheel-mounted brake disk
2a, 2b friction disk
3, 3a, 3b, 3c, 3d, 3e cooling fin
4 fastening boss
4a through-hole
4b fastener
inner diameter
6 outer diameter
7 air inlet
7a air flow
8 air outlet
8a, 8b air flow
9; 10, 10a, 10b; 11 round stem
11a upper side
12 annular fin
12a outer side
12b inner side
13 aperture portion
14, 15, 16, 17, 18 diameter
19 radial slot
20, 20a circle sector
AF contact surface
K cooling channel
R rear side
RF friction face
SP gap

What is claimed is:

1. A wheel-mounted brake disk, comprising:
at least two friction disks, arranged on both sides of a stem of a wheel body of a rail wheel and fastened by fasteners,
wherein the at least two friction disks include cooling fins and fastening bosses,
wherein the fasteners extend through the fastening bosses of the at least two friction disks and through the stem,
wherein the at least two friction disks include round stems, and at least one annular fin, wherein the round stems and the at least one annular fin form the cooling fins.

2. The wheel-mounted brake disk according to claim 1,
wherein the round stems are arranged on the at least two friction disks on circles with different diameters, and
wherein the at least one annular fin is arranged as a circumferential annular fin on a circle having a diameter that is located at an outer diameter of each of the at least two friction disks.

3. The wheel-mounted brake disk according to claim 2, wherein the at least two friction disks include additional round stems, which are connected by the at least one annular fin.

4. The wheel-mounted brake disk according to claim 3,
wherein the additional round stems connected by the at least one annular fin are arranged at uniform angular intervals relative to one another, and
wherein the uniform angular intervals have an angular value that is in a range of 3° to 15°, or 5° to 10°, or the angular value is 5°.

5. The wheel-mounted brake disk according to claim 3, wherein the additional round stems connected by the at least one annular fin respectively have a circular-cylindrical cross-section.

6. The wheel-mounted brake disk according to claim 3, wherein an axial length of the additional round stems connected by the at least one annular fin axially protrudes further by a predetermined amount from a rear side of the at least two friction disks, than the at least one annular fin.

7. The wheel-mounted brake disk according to claim 6, wherein a respective section of the at least one annular fin between two respective additional round stems and the stem of the associated wheel body forms an aperture section configured as a gap for an air outlet.

8. The wheel-mounted brake disk according to claim 3, wherein the additional round stems that are connected by the at least one annular fin respectively include contact surfaces configured to contact the stem of the associated wheel body.

9. The wheel-mounted brake disk according to claim 1,
wherein first round stems of the round stems include contact surfaces configured to contact the stem of the associated wheel body, and
wherein second and third round stems of the round stems are configured axially shorter by a certain amount, than the first round stems of the round stems.

10. The wheel-mounted brake disk according to claim 7,
wherein the first round stems of the round stems that include the contact surfaces are arranged on a first circle that has a first diameter, and
wherein the first circle is located at an inner diameter of the respective friction disk.

11. The wheel-mounted brake disk according to claim 1, wherein the round stems have a conical shape, wherein a largest diameter of the conical shape is located at a surface of a respective rear side of the at least two friction disks.
